(19) United States
(12) Patent Application Publication
(10) Pub. No.: US 2026/0064851 A1
(43) Pub. Date: Mar. 5, 2026

(54) System and process for anonymizing data based on the risks of each data item

(71) Applicant: COACHMESEC CONSULTING, Bagneux (FR)

(72) Inventor: Louis Philippe SONDECK, Bagneux (FR)

(73) Assignee: COACHMESEC CONSULTING, Bagneux (FR)

(21) Appl. No.: 19/228,319

(22) Filed: Jun. 4, 2025

(30) Foreign Application Priority Data
Aug. 27, 2024 (EP) 24196804.9

(51) Int. Cl. G06F 21/57; G06F 21/62

(52) U.S. Cl. CPC G06F 21/577; G06F 21/6254; G06F 2221/2113

(57) ABSTRACT

The invention relates to a program based on a data anonymization system wherein the system comprises a module for identifying data and assigning an exposure level with respect to individuals inside or outside the user's organization; a module for identifying feared events and their severity; a module for assessing a legal anonymization criteria avoiding re-identification of individuals; a module for evaluating the level of exploitability of the data; a module for assessing the overall risk of the dataset, in which data with a significant level of exploitability and/or severity are identified; and a module for correcting data and implementing countermeasures or transforming data with a significant level of exploitability and/or severity, in order to reduce that level.

### CROSS-REFERENCE TO RELATED APPLICATIONS

This application claims priority to European Patent Application No. EP24196804.9, filed on Aug. 27, 2024, the contents of which are incorporated by reference in their entirety.

### TECHNICAL FIELD

The invention relates to the field of systems and methods for processing and anonymizing personal data and means for re-identifying individuals.

### BACKGROUND OF THE INVENTION

Personal data has become a valuable asset in science and technology. It is particularly useful for conducting clinical studies, testing and validating computer applications, and is crucial in the field of machine learning and artificial intelligence.

Unfortunately, the use of personal data is currently hampered by the implementation of legislation relating to the protection of personal data (e.g., GDPR, CCPA, HIPAA, etc.). This legislation specifies, in particular, that to use personal data for the purposes described above, it must be anonymized, that is, transformed into data that is no longer personal.

Thus, several measures have been proposed to anonymize data, but they are not entirely satisfactory. A common strategy is pseudonymization (of which data masking is a variant), which consists of replacing one attribute with another, thus aiming to limit the risk of an individual's identification. In other words, directly or indirectly identifying data (such as last name, first name, email address, postal address) are replaced with pseudonyms (such as an alias, a number, etc.).

Another strategy is the use of so-called synthetic data in place of real data to protect individuals. Synthetic data is data generated from the original data, relying on artificial intelligence models; it has the particularity of preserving the properties of real data while not containing any real information.

Unfortunately, pseudonymization is not entirely satisfactory because it is considered reversible. If a pseudonymized dataset is robbed, it is possible for the author to reconstruct the personal data relatively easily. Thus, pseudonymized data is still considered personal data by regulations. Furthermore, synthetic data is difficult to use because it is generally difficult to produce datasets that truly reflect the original data, which leads to a lack of reliability of synthetic data. Furthermore, generating synthetic data is a time-consuming operation that requires creating a new model for each dataset.

Anonymization in the strict sense is defined at the European level by the Article 29 Working Party on Data Protection (abbreviated as WP29) Group. According to this group, an anonymization solution must be developed on a case-by-case basis and adapted to the intended uses. To help evaluate a good anonymization solution, the WP29 proposes three criteria:
Individualization: Is it still possible to isolate an individual after anonymization?
Correlation: Is it possible to link separate data sets concerning the same individual?
Inference: Can information about an individual be deducted?

Thus, for the WP29, a data set for which it is not possible to individualize, correlate, or infer is a priori anonymous. Furthermore, a dataset for which at least one of the three criteria is not met can only be considered anonymous following a detailed re-identification risk analysis. The tools for implementing the recommendations of the Working Group 29 are not proposed in the prior art.

Unfortunately, the criteria presented in the Working Group 29 opinion are too strict and unusable as they stand, as they systematically produce excessively high risks, leading to the application of overly rigorous anonymization, which tends to significantly destroy the data, rendering it unusable in an anonymized form.

Faced with this observation, the CNIL proposes two ways to assess the risks: either scrupulously respect these criteria or conduct a re-identification risk analysis. However, the CNIL provides very little guidance on how to conduct this re-identification risk analysis.

The main difficulties are 1) being able to calculate re-identification scores according to the three criteria of the Working Group 29; 2) being able to explain the scores calculated according to re-identification risks; 3) integrating them into a risk analysis approach following the EBIOS model, recommended by the CNIL.

### SUMMARY OF THE INVENTION

Thus, one objective of the present invention is to address the defects of the prior art, and in particular to propose a data anonymization solution that significantly limits the risk of re-identification while allowing the use of the data in an anonymized form. The invention relies on a risk assessment tool for individualization, correlation, and inference, enabling, depending on the risk value, to transform only the data items that poses the greatest risk to individuals. Thus, the tool allows for minimal degradation of the dataset in order to preserve its qualities in an anonymized form.

In order to achieve these objectives, the invention proposes a system for anonymizing personal, the system taking as input at least one data set from an organization, the anonymization system comprising:
a means for characterizing the data based on a “data schema,” enabling to define, for each data item, a name, a level of exposure enabling assessing the possibility of access to the data item depending on whether it can be accessed from outside the organization or from within it, and preferably a type of sensitivity of the data item;
a means for identifying feared events, enabling to define, for each data item, a severity scale, preferably broken down into a type of feared event and/or a scale of impact of this event, assessed on the basis of at least one given criterion having a number of variables;
a means for assessing a legal anonymization criteria, enabling to define, for each data item, an individualization score, a correlation score, and an inference score;
a means for assessing a level of exploitability determined based on a combination of the levels of exposure and the individualization, correlation, and inference scores;
a means for assessing an overall risk of the dataset based on risk hypotheses constructed based on data having a significant level of exploitability and a significant severity scale; and
preferably a means for reducing risks comprising proposed countermeasures or transformations to limit the level of exploitability and/or the severity scale of the most at-risk data item.

A significant level of exploitability is understood as a level of exploitability above average, preferably a high level of exploitability. A significant severity scale is understood as a severity scale above average, preferably a high severity scale.

Advantageously, the invention makes it possible to assess the risk of the various data items in a dataset and to transform a portion of the data, those involving significant risk, so that the dataset is anonymized without significantly degrading its quality.

The invention is also a digital tool for analyzing data and proving that the risks inherent in the data used have been validly assessed. The invention provides a simplified way to prove that the risk assessment has been carried out and is applicable to large volumes of data (hundreds or even thousands of variables).

According to an embodiment, the means for characterizing enable assigning a level of exposure to each data item based on variables, the number of which can vary between 2 and 10, preferably four variables, more preferably among:
a “restricted internal” level if the data item is accessible to a limited number of people within the user's organization;
an “extended internal” level if the data item is accessible to any people within the user's organization;
a “restricted external” level if the data item is accessible to a limited number of people outside the user's organization;
an “extended external” level if the data item is accessible to any person outside the user's organization.

This enables assessing risk assessments differently depending on whether the data item is accessible to a third party, in order to achieve more precise risk assessments and improve the quality of anonymized data. The level of exposure enables having more precise calculations of the correlation criterion and identification of the highest-risk data item.

According to an embodiment, the means for characterizing enables assigning to each data item a sensitivity type based on three variables, preferably from among:
a sensitive data type if the data item may have personal impacts on the concerned subject;
a perceived sensitive data type if the data item is perceived as sensitive;
a common data type if the data item is routine and not sensitive.

This enables differentiating the sensitivities of different data items to better assess risk and improve the quality of anonymized data.

According to an embodiment, the means for identifying feared events enables assigning at least one seriousness scale with four variables, preferably: minor, significant, serious, and critical.

This enables easily assessing the seriousness of disclosure for each data item and the data set. It also enables noting these events for each data item and providing them in a report.

According to an embodiment, the means for assessing the legal anonymization criteria enables assigning scores with a given number of levels that can vary between 3 and 5, preferably: low, moderate, high, very high.

This simplifies the assessment of the risk of re-identification.

According to an embodiment, the means for assessing the level of exploitability enables assigning exploitability levels with a number of values that can vary between 3 and 5, preferably very difficult, difficult, easy, very easy.

This simplifies the assessment of the risk of data exploitability by a third party.

According to an embodiment, the system further comprises a means for generating a color code with a scale of importance for at least one assessed level.

This enables rapidly visualizing the dangerousness of an assessed risk.

According to an embodiment, the system further comprises a means for producing a report including among other things the identified risks and/or countermeasures.

This enables to prove to a third party or an institution that the risks have been assessed and measures have been taken to minimize them.

Another subject-matter of the invention relates to a method for anonymizing personal data in at least one user dataset, the method for anonymizing comprising:
a step for characterizing the data based on a data schema in which to each data item is assigned a name, a level of exposure enabling assessing the possibility of access to the data item depending on whether it can be accessed from outside the organization or from within it;
a step for identifying feared events in which to each data item is assigned a severity scale, assessed on the basis of at least one given criterion having a number of variables;
a step for assessing the legal anonymization criteria in which to each data item is assigned an individualization score, a correlation score, and an inference score;
a step for assessing a level of exploitability based on a combination of exposure levels and individualization, correlation, and inference scores;
a step for assessing the overall risk of the dataset based on risk hypotheses constructed based on data having a significant level of exploitability and a significant severity scale.

According to an embodiment, the method further comprises a risk reduction step comprising proposals for countermeasures or transformations to limit the level of exploitability and/or the severity scale of the most at-risk data item.

The invention further relates to a computer program comprising program code instructions for executing the steps of a data anonymization method according to the invention, when said program operates on a computer.

### BRIEF DESCRIPTION OF DRAWINGS

The invention will be further detailed by describing non-limiting embodiments, and on the basis of the appended figures illustrating preferred embodiments of the invention, in which:

FIG. 1 schematically illustrates an anonymization system according to a preferred embodiment of the invention, and a report output that may be physical or electronic;

FIG. 2 schematically illustrates an anonymization method according to an embodiment;

FIG. 3 schematically illustrates a first example of data risk analyses of a dataset using the invention, before and after applying a maximum of countermeasures according to the invention for an internal hacker or an external hacker; and

FIG. 4 schematically illustrates a second example of data risk analyses similar to that of FIG. 3 with minimal countermeasures according to the invention.

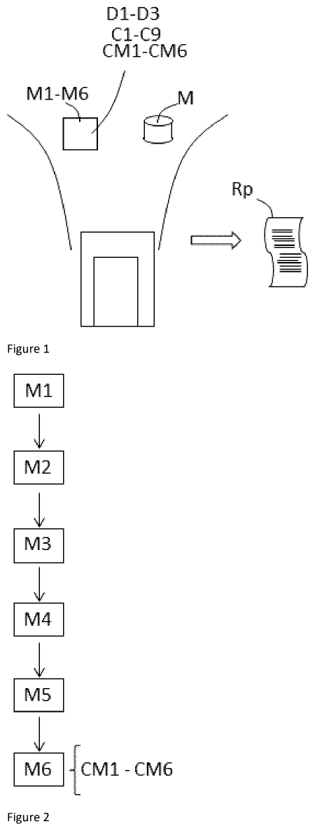

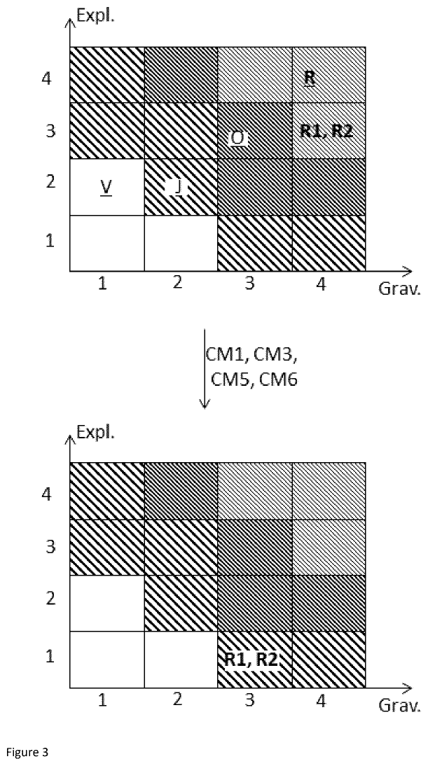

### DETAILED DESCRIPTION

The invention relates to a system and method for anonymizing personal data in at least one user dataset.

The invention is implemented by computer means, for example via a computer, a server, a tablet, a smartphone, or the like, or a combination of at least two of these elements.

The anonymization system comprises several hardware and software means for loading and evaluating the data, preferably transforming it, or proposing countermeasures to improve the security of the dataset.

The described means and step relating to the system or computerized devices may be interpreted as computer modules, such as a computer module for loading and evaluating the data.

The anonymization system comprises a means for loading at least one dataset to be analyzed. This is in particular a module for reading a file containing said dataset. The dataset can be in any file format, for example, a computer workbook format (known as “.csv”).

The anonymization system further comprises a means for identifying a data schema. The data schema is illustrated in Table 1. In this data schema, to each data item is assigned a name, preferably a label, a level of exposure to people inside or outside the user's organization, and preferably a type of sensitivity of the data item.

TABLE 1
Example of data schema

| # | Name | Label | Exposure | Sensitivity |
|---|---|---|---|---|
| 1 | Antibiogram | Molecule X | 1-Restricted internal | common |
| 2 | Bacterial specie | Specie Y | 1-Restricted internal | common |
| 3 | Type of sample | 8 modalities | 1-Restricted internal | common |
| 4 | Date of sample | Shifted by a | 2-Extended internal | common |
| | | random number | | |
| 5 | MALDI-ToF | Single vector | 1-Restricted internal | common |
| | spectrum | 1000 values | | |
| 6 | Date of birth | Rounded to | 4-Extended external | common |
| | | 5 years | | |
| 7 | Sex | Two categories | 4-Extended external | common |

In the field of health or clinical studies, the name of the data item is, for example, antibiogram; bacterial specie; sample type; sampling date; a particular test name, for example, MALDI-ToF spectrum; date of birth, gender. The “Name” can be an ID number, a license number, a number of points in the field of road safety, or the name of a test in another technical field.

In addition to the “Name”, the “Label” can be defined to enter a brief description of the data item.

The level of “Exposure” of an attribute assesses how easily a hacker can obtain the information in question from another dataset. For example, it is likely more difficult to obtain a person's “Sampling Type” from another dataset than to find their “Date of Birth” or “Gender”.

The level of “Exposure” is differentiated based on the third parties internal to the organization using the dataset, and those internal or external to this organization who do not have access to the data. Furthermore, the level of exposure is preferably identified by fewer than ten discrete variables, preferably four.

The level of Exposure can be classified into four main categories in ascending order of level:
restricted-internal;
extended-internal;
restricted-external; and
extended-external.

Regarding the restricted-internal level: attributes with a restricted-internal level of exposure are accessible only to a limited number of authorized individuals. These attributes may include medical information, sensitive financial data, or sensitive personal information.

In particular, a “restricted internal” level is used if the data is accessible to a limited number of individuals within the user's organization, for example, individuals within a specific department.

A traffic light-style color code can be generated based on the level of exposure (or exposure level). The restricted internal level is, for example, green V because data in this category are less likely to be found in other datasets.

For example, bacterial species, analysis results, and banking transactions can have a restricted internal level and a green color code V.

Regarding the extended internal level: attributes with an extended internal exposure level are accessible within the organization, by employees belonging to several departments or by all employees. These attributes can include employee identification data, internal activity reports, but also data of given subjects (e.g., patients, customers, etc.) passing from one department to another (e.g., customer/patient IDs, heights, weights, blood pressures, etc.).

Specifically, data has this exposure level if it is accessible to any person within the organization or to several different departments. The color code is, for example, yellow J.

Regarding the restricted external level: Attributes with a restricted external exposure level are accessible to third parties, but require specific research or specific data sources to access them. They may include information shared with business partners, survey data, or industry-specific information.

In particular, data has this level if it is accessible to a limited number of people outside the user's organization due to the complexity required to collect it. This includes people who may be familiar with the information in question or find it through in-depth research. For example, an admission date or a discharge date may have a restricted external level. The color code is, for example, orange O (or dark orange).

Regarding the extended external level: Attributes with an extended external exposure level are easily accessible and can be obtained from external sources without too much difficulty. These attributes may include publicly available information, such as a last name, first name, age, postal address, email address, or general professional data.

In particular, data is at this level if it is accessible to anyone outside the user's organization, for example, via social media and search engines. The color code is, for example, red R.

Data breach depends, among other things, on the ability to cross-reference different datasets and therefore the ability to find data items present in the anonymized dataset in another dataset.

In the context of the invention, the aim is to be able to assign a score between 1 and 4 that quantifies the degree of exposure of an attribute in the dataset. It comes quite naturally to propose the following scores: extended external with a score equal to 4 (critical), restricted external with a score equal to 3 (high), extended internal with a score equal to 2 (medium), and restricted internal with a score equal to 1 (low).

A high exposure score may be a sign that randomization should be applied to this attribute. This could make it more difficult to find adequate values in external sources.

In addition to the exposure level, the means for characterizing enables assigning to each data item a sensitivity type with three variables. This can be referred to as a CNIL data type. We can distinguish:
a sensitive data type if the data concerns racial or ethnic origin, political opinions, religious or philosophical beliefs, or trade union membership, as well as the processing of genetic data, biometric data for the purpose of uniquely identifying a natural person, data concerning health, or data concerning a natural person's sex life or sexual orientation;
a perceived sensitive data type if the data is perceived as sensitive, for example, banking data, biometric data, a social security number;
a common data type if the data is neither sensitive nor perceived as sensitive.

The risk of re-identification depends on this sensitivity.

The anonymization system also comprises a means for identifying feared events. This information provides evidence that this aspect was assessed prior to the data being used. To this end, a severity scale is assigned to each data item to determine a minor, significant, serious, or critical event to be expected in the event of loss of the data item. Preferably, the scale contains fewer than 10 levels, more preferably fewer than 6, and more preferably, 4 variables are used for the severity scale. Furthermore, severity preferably includes a type of feared event, for example, the disclosure of a patient's illness, and/or a scale of the impact of this event, assessed on at least one of three criteria: material, physical, and moral.

TABLE 2
Example of feared events

| Sensitive | | | | | |
|---|---|---|---|---|---|
| attribute | Feared event | Material | Bodily | Moral | Severity |
| Bacterial specie | Disease | Minor | Serious | Critical | Critical |
| | disclosure | | | | |

For better visibility and rapid understanding, feared events are assigned a traffic light-style color code, with a green color V for events of low severity, a yellow color J and/or orange color O for events of intermediate severity, and a red color R for significant severity.

The anonymization system also comprises a means for evaluating the criteria for re-identifying individuals, in which to each data item is assigned an individualization score, a correlation score, and an inference score. In each of these cases, the score is preferably evaluated on a scale of fewer than 10 values, more preferably between 3 and 5 values, and more preferably according to the values: low, medium, high, and critical. These scores can be evaluated collegially, conventionally, or statistically for each data item.

TABLE 3
Re-identification risk assessment

| # | Name | Individualization | Correlation | Inference |
|---|---|---|---|---|
| 1 | Antibiogram | 1-Low | 1-Low | 2-Moderate |
| 2 | Bacterial specie | 3-High | 1-Low | 4-Very high |
| 3 | Type of sample | 1-Low | 1-Low | 1-Low |
| 4 | Sample date | 4-Very high | 3-High | 4-Very high |
| 5 | MALDI-ToF | 3-High | 1-Low | 3-High |
| | spectrum | | | |
| 6 | Date pf birth | 2-Moderate | 3-High | 2-Moderate |
| 7 | Sex | 1-Low | 3-High | 1-Low |

Similarly, the traffic light-type color code can be used. Critical risk is red R; high risk is orange O; medium risk is yellow Y; and low risk, green V.

The individualization score can be assessed or calculated. Individualization evaluates the possibility of isolating an individual in the dataset. It refers to the level of detail or specificity of the information contained in each attribute. Some attributes may be very granular, providing precise information such as the full date of birth or full address. Other attributes may be more general, with a lower individualization score, such as the year of birth or city of residence. The individualization score of attributes can influence the potential for disclosure and the associated risk level.

A high individualization score can be addressed by applying generalization. However, it is still important to consider the loss of data utility that may accompany generalization.

The risk of inference can be assessed or calculated. Inference can be likened to the statistical concept of discrimination rate. This is a metric that assesses an attribute's ability to distinguish or discriminate an individual from others. It is often used to assess the risk of re-identification of individuals from anonymized data. An attribute with a high discrimination rate can provide information that can identify or reveal specific personal characteristics, increasing the risk of privacy violations.

As with the r_{X} ratio obtained for the granularity measure, the discrimination rate is a value in the interval [0, 1]. By denoting this metric DR, we can define the associated S_{DR} score in a similar way to the granularity score:

$${S}_{DR} = ⌈ 4 \cdot DR ⌉$$

with ┌⋅┐ the upper integer, also called the “ceiling”.

The correlation criterion is evaluated based on the exposure level and the individualization criterion.

The anonymization system further comprises a means for assessing the exploitability level, comprising at least a combination of exposure and risk levels for individualization, correlation, and inference. In essence, when the scores are high, then exploitability is easy, and a hacker can easily gain access to personal data; and vice versa.

TABLE 4
Exploitability Risk Assessment

| # | Individualisation | Correlation | Inference | Exploitability |
|---|---|---|---|---|
| 1 | 1-Low | 1-Low | 2-Moderate | 1-Very difficult |
| 2 | 3-High | 1-Low | 4-Very high | 2-Difficult |
| 3 | 1-Low | 1-Low | 1-Low | 1-Very difficult |
| 4 | 4-Very high | 3-High | 4-Very high | 4-Very easy |
| 5 | 3-High | 1-Low | 3-High | 2-Difficult |
| 6 | 2-Modere | 3-High | 2-Moderate | 3-Strong |
| 7 | 1-Low | 3-High | 1-Low | 2-Difficult |

An exploitability assessment scale can be as follows in Table 5.

TABLE 5
Means for assessing exploitability risks

| Category | Individualization | Correlation | Inference | Exploitability |
|---|---|---|---|---|
| Extended-external | 1-Weak | 2-Moderate | 1-Weak | 1-Very difficult |
| (sex) | | | | |
| Extended-internal | 4-Very high | 3-High | 4-Very high | 4- Very easy |
| (sample date) | | | | |
| Restricted-internal | 4-Very high | 1-Weak | 4-Very high | 2-Difficult |
| (Antibiogr.) | | | | |

A color code can be assigned to exploitability. The Very easy level is in red R, difficult in yellow J, and very difficult in green V.

The anonymization system also comprises a means for assessing the overall risk of the dataset, in which data with a significant exploitability level and/or a significant severity level are identified.

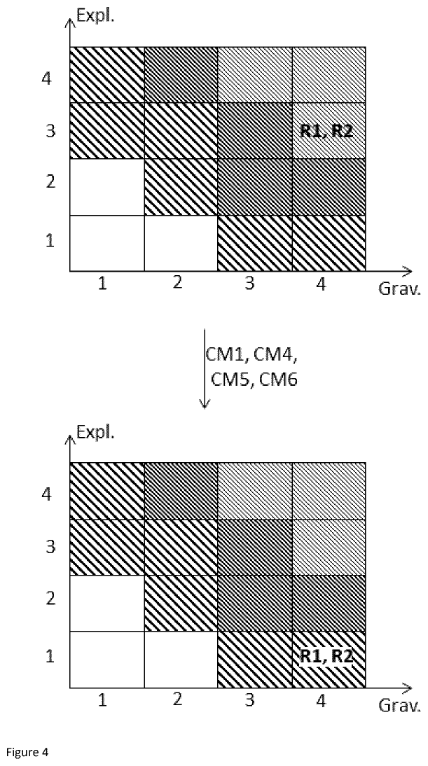

The exploitability level and severity level are preferably represented in a two-dimensional graph (one for each level) to better visualize risks and easily compare anonymized datasets. The graph preferably comprises a traffic light-style color code. This type of graph is illustrated in FIGS. 3 and 4.

The anonymization system further comprises a means for correcting the dataset, including proposals, preferably automatic, for countermeasures or transformations of data with a significant exploitability level and/or a significant severity level to reduce said level.

The system can alert on identification risks at high exploitability levels, identify vulnerabilities via initial vulnerability modules denoted D1, D3, etc., and propose corresponding countermeasures:
module D1 requires the maximum generalization of variables involving a high (easy) exploitability level, for example, broad internal variables such as sampling dates.
module D3 identifies the risks of re-identification linked to restricted internal variables.

The system can also analyze GDPR compliance using at least one of the following specific vulnerability modules:
module C1 requiring compliance with the data minimization principle (because only data strictly necessary for the study must be used according to the regulations, in which case a list of data must be defined and the use made must be justified);
module C2 requiring deletion of data of specific individuals;
module C3 requiring definition of a reasonable data retention period based on the purpose of the data processing;
module C4 requiring provision of a data purge mechanism at the end of data processing;
module C5 prohibiting the export of data from the system;
module C6 requiring information to be provided to data subjects that the data will be anonymized;
module C7 alerting on the location of the data, because the data must be located within the EU zone; otherwise, standard or binding contractual clauses with the cloud provider must be signed;
a module C8 requiring the stakeholder to agree not to attempt to re-identify individuals; it can be combined with module D3;
a module C9 requiring a high-security password, for example, in accordance with ANSSI recommendations.

The anonymization system also comprises a means for generating a report Rp detailing the identified risks and countermeasures. The report Rp automatically includes the risk analysis elements and serves as evidence to demonstrate to authorities that the risks have been assessed and minimized. The report Rp can be physical or electronic.

### Example R1

Hypothetically, a hacker exfiltrates insufficiently anonymized data after exploiting an authentication weakness and reidentifies the individuals concerned based on extended internal variables. The system of the invention analyzes the data and identifies vulnerabilities in modules D1, D3, C2, and C8 with a high risk of re-identification (e.g., level 4—very easy (red R)).

A first set of countermeasures is proposed: for D1, a countermeasure CM1: generalize the extended internal variables; for C8, another countermeasure CM3: define a password policy using ANSSI standards; for C2, another countermeasure CM5: delete the data of special individuals; for D3, other countermeasures CM6: generalize the restricted internal variables.

The countermeasures limit the risk, which goes from level 4—Critical to level 2—Medium.

On an initial exploitability scale of 3/4, and a severity scale of 4/4 directly visible in the system (top of FIG. 3), the countermeasures lower the exploitability to 1/4, and the severity to 3/4, as shown at the bottom of FIG. 3.

The system can propose minimal countermeasures to consider, here CM1 and CM3. The countermeasures maintain the risk at level 2—Medium. In this case, the severity remains at 4/4, but the exploitability drops to 1/4, as illustrated in FIG. 4.

### Example R2

Hypothetically, a researcher re-identifies the concerned individuals based on restricted internal variables. The system of the invention analyzes the data and identifies vulnerabilities in modules D1, D3, C2, and C7 with a high risk of re-identification (e.g., level 4—very easy (red)).

A first set of countermeasures is proposed: for D1, a countermeasure CM1: generalize the extended internal variables; for D3 and C7, other countermeasures CM6: generalize the restricted internal variables and CM4: provide contractual measures for the operator, who agrees not to attempt to re-identify individuals; for C2, another countermeasure CM5: delete the data of specific individuals.

The countermeasures limit the risk, which reaches level 2—Medium.

On an initial exploitability scale of 3/4, and a severity scale of 4/4 directly visible in the system, the countermeasures lower the exploitability to 1/4, and the severity to 3/4, as illustrated in FIG. 3.

The system preferably proposes minimum countermeasures to be considered, here CM1 and CM4. The countermeasures maintain the risk at level 2-Medium. In this case, the severity remains at 4/4, but the exploitability drops to 1/4, as illustrated in FIG. 4.

Preferably, the correlation level is determined based on the exposure level and the individualization level, based on the following table:

TABLE 6
Correlation Level Assessment

| | Exposure | | | |
|---|---|---|---|---|
| | Restr. | Exten. | Restr. | Exten. |
| Individualisation | internal | internal | external | external |
| Very high | 1-low | 3-High | 4-Very high | 4-Very high |
| High | 1-low | 2- Moderate | 4-Very high | 4-Very high |
| Moderate | 1-low | 2- Moderate | 3-High | 3-High |
| Low | 1-low | 1-low | 2- Moderate | 2- Moderate |

Preferably, the exploitability level is determined based on the correlation level and the inference level, based on the following table:

TABLE 7
Exploitability Level Assessment

| | Exploitability | | | |
|---|---|---|---|---|
| Inference | 1-low | 2- Moderate | 3-High | 4-Very high |
| Very high | 2-Difficult | 3-Easy | 4-Very easy | 4-Very easy |
| High | 2-Difficult | 2-Difficult | 3-Easy | 4-Very easy |
| Moderate | 1-Very difficult | 2-Difficult | 3-Easy | 3-Easy |
| Low | 1-Very difficult | 1-Very difficult | 2-Difficult | 3-Easy |

Preferably, a contextual exploitability level is determined based on the exploitability level and the above remarks and countermeasures, based on the following table:

TABLE 8
Contextual exploitability Level Assessment

| Contextual | Exploitability of the data | | | |
|---|---|---|---|---|
| exploitability | 1-Low | 2- Moderate | 3-High | 4-Very high |
| Very easy | 2-Difficult | 3-Easy | 4-Very easy | 4-Very easy |
| Easy | 2-Difficult | 2-Difficult | 4-Very easy | 4-Very easy |
| Difficult | 1-Very difficult | 2-Difficult | 3-Easy | 3-Easy |
| Very | 1-Very difficult | 1-Very | 2-Difficult | 3-Easy |
| difficult | | difficult | | |

Preferably, the risk of re-identification (legal anonymization criteria) is determined based on the severity level and the exploitability level (preferably contextual exploitability) based on the following table:

TABLE 9
Exploitability Level Assessment

| | Severity | | | |
|---|---|---|---|---|
| Exploitability | Negligible | Limited | Significant | Maximum |
| Very easy | 2-Medium | 3-High | 4-Critical | 4-Critical |
| Easy | 2-Medium | 2-Medium | 3-High | 4-Critical |
| Difficult | 1-Low | 2-Medium | 3-High | 3-High |
| Very difficult | 1-Low | 1-Low | 2-Medium | 2-Medium |

The invention further relates to a method for anonymizing personal data in at least one user dataset, based on a system as described above.

The method comprises steps for implementing the various modules.

The method is implemented by computer.

The invention also relates to a computer program for implementing the invention via computer means, which may be computer modules.

More generally, in the interpretation of the invention, the functional features denoted “means for” may be interpreted as computer modules. The functional features denoted “step for” may be interpreted as actions of computer modules or elements.

1. A system for anonymizing personal data, the system taking as input at least one data set from an organization, the anonymization system comprising:
a means for characterizing the data based on a data schema enabling to define, for each data item, a name, a level of exposure enabling assessing the possibility of access to the data item depending on whether it can be accessed from outside the organization or from within it;
a means for identifying feared events, enabling to define, for each data item, a severity scale assessed on the basis of at least one given criterion having a number of variables;
a means for assessing a legal anonymization criteria, enabling to define, for each data item, an individualization score, a correlation score, and an inference score;
a means for assessing a level of exploitability determined based on a combination of the levels of exposure and the individualization, correlation, and inference scores;
a means for assessing an overall risk of the dataset based on risk hypotheses constructed based on data having a significant level of exploitability and a significant severity scale.

2. The system according to claim 1, further comprising a means for reducing risks comprising proposed countermeasures or transformations to limit the level of exploitability and/or the severity scale of the most at-risk data item.

3. The system according to claim 1, wherein the means for characterizing enables assigning a level of exposure to each data item based on variables, the number of which being predetermined.

4. The system according to claim 3, wherein, the means for characterizing enables assigning a level of exposure to each data item based on four variables among:
a restricted internal level if the data item is accessible to a limited number of people within the user's organization;
an external internal level if the data item is accessible to any people within the user's organization;
a restricted external level if the data item is accessible to a limited number of people outside the user's organization;
an extended external level if the data item is accessible to any person outside the user's organization.

5. The system according to claim 1, wherein the means for characterizing enables assigning to each data item a sensitivity type based on three variables.

6. The system according to claim 3, wherein the three variables are selected among:
a sensitive data type if the data may have personal impacts on the concerned subject;
a perceived sensitive data type if the data is perceived as sensitive;
a common data type if the data is routine and not sensitive.

7. The system according to claim 1, wherein the means for identifying feared events enables assigning at least one seriousness scale with four variables.

8. The system according to claim 1, wherein the means for assessing the legal anonymization criteria enables assigning scores with a given number of levels.

9. The system according to claim 1, wherein the means for assessing the level of exploitability enables assigning exploitability levels with a given number of values.

10. The system according to claim 1, wherein the system further comprises a means for generating a color code with a scale of importance for at least one assessed level.

11. The system according to claim 1, wherein the system further comprises a means for producing a report including among other things the identified risks and/or countermeasures.

12. A method for anonymizing personal data in at least one user dataset, the method for anonymizing comprising:
a step for characterizing the data based on a data schema in which to each data item is assigned a name, a level of exposure enabling assessing the possibility of access to the data item depending on whether it can be accessed from outside the organization or from within it;
a step for identifying feared events in which to each data item is assigned a severity scale, assessed on the basis of at least one given criterion having a number of variables;
a step for assessing the legal anonymization criteria in which to each data item is assigned an individualization score, a correlation score, and an inference score;
a step for assessing a level of exploitability based on a combination of exposure levels and individualization, correlation, and inference scores;
a step for assessing the overall risk of the dataset based on risk hypotheses constructed based on data having a significant level of exploitability and a significant severity scale.

13. The method according to claim 12 further comprising a risk reduction step comprising proposals for countermeasures or transformations to limit the level of exploitability and/or the severity scale of the most at-risk data item.

14. A computer program comprising program code instructions for executing the steps of a data anonymization method, when said program operates on a computer, the method for anonymizing comprising:
a step for characterizing the data based on a data schema in which to each data item is assigned a name, a level of exposure enabling assessing the possibility of access to the data item depending on whether it can be accessed from outside the organization or from within it;
a step for identifying feared events in which to each data item is assigned a severity scale, assessed on the basis of at least one given criterion having a number of variables;
a step for assessing the legal anonymization criteria in which to each data item is assigned an individualization score, a correlation score, and an inference score;
a step for assessing a level of exploitability based on a combination of exposure levels and individualization, correlation, and inference scores;
a step for assessing the overall risk of the dataset based on risk hypotheses constructed based on data having a significant level of exploitability and a significant severity scale; and
a risk reduction step comprising proposals for countermeasures or transformations to limit the level of exploitability and/or the severity scale of the most at-risk data item.
